(19) United States
(12) Patent Application Publication
(10) Pub. No.: US 2010/0036778 A1
(43) Pub. Date: Feb. 11, 2010

(54) MONITORING OF THE UTILISATION TIME OF A PALLET

(76) Inventor: Jean DE Vulliod, Angers (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 12/442,861

(22) PCT Filed: Sep. 26, 2007
(86) PCT No.: PCT/FR07/52016

§ 371 Date: Oct. 8, 2009

(30) Foreign Application Priority Data
Sep. 26, 2006 (FR) 0653935

(51) Int. Cl. G06Q 90/00; B65D 19/38

(52) U.S. Cl. 705/500

(57) ABSTRACT

The present invention relates to a method for visually monitoring the utilization time of a handling pallet. By limiting the utilization time, the present invention guarantees the quality and the maintenance of said pallet, and implements an insurance covering any risk in case of accident or damage.

### BACKGROUND OF THE INVENTION

(1) Field of the Invention

This invention relates to a method for visually monitoring the utilization time of a handling pallet.

This invention also relates to means for visual identification of the utilization time of a handling pallet.

This invention falls within the field of handling, more specifically within the field of the transport of goods on pallets.

(2) Description of the Prior Art

A pallet is a load platform designed to group goods so as to form a loading unit. As a storing, handling or transport platform, it is designed to be handled by lifting trucks called pallet jacks.

There are several types of standard-size standardized pallets, viz. block pallets or stringer pallets, two way entry pallets or four way entry pallets. Pallets can also be reversible. Further, a pallet is usually made of boards and wooden material or wooden particles but can also be made of plastic, cardboard or metal, such as aluminum.

A pallet includes, on the one hand, a top deckboard consisting of a juxtaposition of planks or of a solid panel and, on the other hand, of a bottom deckboard, itself made of planks. The top and bottom deckboards are separated from each other by means of blocks or stringers, forming a space for handling by a pallet jack. The bottom deckboard can be made of base boards—3, 5 or 7 according to the case.

Some pallets are designed to be used for a single cycle and are called <<single-use pallets>>. However, a pallet will preferably be reused over several cycles. For this purpose, traceability means have been implemented in order to ensure the monitoring of each pallet during its circulation, identifying it in a unique manner, as well as its load.

These traceability means are known in the state of the art under different forms, such as electronic means enclosed inside the structure of the pallet or in the form of labels provided with a barcode or with a radio identification system, also called <<RFID >>.

Thus, traceability brings a solution for identifying each pallet, its advance, the goods it transports, etc. A disadvantage resides however in that, even though it is possible to store data connected with the date of putting into circulation of said pallet via the traceability means, the monitoring of its utilization time cannot be performed quickly and directly by the user.

As a matter of fact, from one cycle to another or during the circulation of a pallet, there is a problem raised with respect to its maintenance and, therefore, the monitoring of operations carried out on this pallet. In case of failure of a pallet supplied by a company, the latter can be held responsible for material losses and consequential and non consequential damages. Therefore, there is a risk for the supplier whose liability can be called into question.

### SUMMARY OF THE INVENTION

The object of the invention is to cope with the disadvantages of the state of the art by proposing to ensure the visual monitoring of the utilization time of a handling pallet during a utilization cycle. This monitoring of the pallet provides the customer with a guarantee about the quality of supplied pallets and their maintenance.

Therefore, the object of this invention also consists in providing a contractual insurance to the customer on each rented pallet by means of direct and visual monitoring of the utilization time of said pallet.

The invention claims to be able to limit the utilization time of a pallet to a given period by means of direct monitoring of said utilization time in view of ensuring the maintenance of said pallet and of providing a guarantee covering risks in case of accidents and damages.

To this end, the invention relates, first of all, to a method for visually and directly monitoring the utilization time of a handling pallet, which consists in:
attaching to said pallet means for visual identification in the form of a label provided with adhesive fastening means, said label changing color according to its time of exposure to air or to light;
verifying the passing of the time of utilization of said pallet by verifying the condition of said identification means ; and
beyond a specified duration, performing a monitoring of said pallet in order to verify its condition and carry out possible maintenance operations; then
attaching new identification means to said pallet.

According to another feature, this visual monitoring method according to claim 1 is characterized in that the means for fastening said label are secured against tearing by means of areas of reduced resistance of said label.

The invention also relates to a handling pallet insurance method, consisting, through contractual exchange between a pallet supplier and a customer, in monitoring the utilization time of each pallet in order to carry out, beyond a specified duration, the maintenance of said pallet, and provide an insurance covering the risks in case of accidents and damages.

Advantageously, this insurance method consists in limiting the utilization time of a pallet to a given period through direct monitoring of said utilization time in view of ensuring the maintenance of said pallet and of providing a guarantee against the risks in case of accidents and damages.

Other features and advantages of the invention will become clear from the following detailed description of non-restrictive embodiments of the invention.

### DETAILED DESCRIPTION OF THE PREFERRED EMBODIMENTS

This invention aims at monitoring the condition of a handling pallet over its lifetime, more specifically during its utilization cycle.

The object of the invention is to provide traceability of a handling pallet during its different utilization cycles and to ensure its regular and efficient maintenance.

To this end, the invention aims at monitoring the utilization time of a handling pallet through means for visual identification of this time. This monitoring is therefore performed directly in the area around the foot, without the intervention of any additional device.

To this end, according to the preferred embodiment, these identification means are in the form of a label. The latter is attached to a pallet during its first cycle or at each cycle start.

For this purpose, said label includes means for fastening to said pallet. These fastening means can be of any type but are preferably in the form of an adhesive adapted to materials of which said pallet is composed. Moreover, this adhesive can be greasy in order to provide resistance to different degrees of humidity. Such an adhesive provides a good cohesion with wood, which is the preferred material for pallet manufacturing.

When the identification means are attached to said pallet, one can verify the passing of the utilization time of said pallet just by checking the condition of said identification means.

As a matter of fact, a label according to the invention is made so as to change its appearance according to its time of exposure to air or to light. More preferably, said label can change its color with time. For example, a red label exposed to ultraviolet radiation will lose its color becoming white, passing through different shades. Another type of label can, through its oxidation in the ambient air, turn from white to blue.

According to the embodiments, the whole or part of the label, in particular the background, is colored. According to the desired duration, the label can change its appearance, and therefore its color, within a more or less long period of time.

Therefore, a simple glance permits to verify the color of the label attached to a pallet and to estimate the time during which the latter has been used. This monitoring method permits to quickly monitor a large number of pallets.

Beyond a specified utilization time of said pallet, it will be subjected to monitoring in order to verify its condition and carry out possible maintenance operations, for example repair of blocks, base boards or similar.

When this verification has been performed, new identification means will be attached to said pallet. Preferably, these means are superposed on the old label. By counting the number of labels, one can calculate the number of cycles of the pallet.

In addition, data can be added on said label in order to identify in a unique manner said pallet, its origin and its destination, its utilization, etc. These data can be unique and encrypted, in particular in the form of a barcode. The label can be an electronic chip carrier containing said data. Preferably, this chip can be of the <<radio-label>> type using the radio-identification technology (RFID).

Besides the traceability of each pallet, the invention permits to know the condition of the pallets stock according to their cycle, their supplier or various useful data.

In order to prevent falsification of the identification means, said label includes areas of reduced resistance. Its tearing becomes therefore more complicated and tedious. These areas of reduced resistance can divide said label into several parts or sections so that it is impossible to unstick it in its entirety.

Therefore, the invention relates to the utilization of a label changing its color with time, for the monitoring of the utilization time of a handling pallet.

As mentioned above, these means for identifying and for monitoring the condition and time during the utilization of a handling pallet provide, besides a complete traceability, a guarantee about the security and quality of the product, eventually in conformity with an established standard.

For this purpose, this invention also relates to a handling pallet insurance method.

As a matter of fact, based on the fact that it is possible to quickly determine how long a pallet has been used, it is then possible to provide the user with a guarantee against risks in case of accidents and damages.

Actually, the delivery of said labels can be made by a company or a certifying body. This body can also act as an inspector during the repair of damaged pallets and/or during the reprocessing, at the end of their lifetime, of said pallets. This certification allows therefore the implementation of means capable of insuring each pallet in case of accidents and damages, through an insurance connected with civil liability. In addition, the progressive and more or less rapid alteration of identification means with time permits to obtain an insurance of a time-limited and specified duration.

Moreover, the monitoring of the utilization time of a pallet provides the possibility of limiting the latter. Having a specified utilization duration, it is then contemplated by this invention to provide, through contractual exchange between a pallet supplier and a customer, a guarantee against possible damages and risks.

Thus, such a method consists first of all in monitoring the utilization time of each pallet in order to carry out, beyond a specified duration, the maintenance of said pallet and provide an insurance covering the risks in case of accidents and damages.

According to a more specific embodiment, said insurance method consists in limiting the utilization time of a pallet to a given period through direct monitoring of said utilization time in order to ensure the maintenance of said pallet and to provide a guarantee against the risks in case of accidents and damages.

Finally, this invention simplifies the monitoring of the utilization time of a pallet, permitting the maintenance of the latter and to therefore provide a guarantee of quality and security to the user. By monitoring the limitation of the utilization time of a pallet, this invention provides the possibility of implementing an insurance covering potential risks and damages.

What is claimed:

1. Method for visually and directly monitoring the utilization time of a handling pallet, which consists in:
attaching to said pallet means for visual identification in the form of a label provided with adhesive fastening means, said label changing color according to its time of exposure to air or to light;
verifying the passing of the utilization time of said pallet by verifying the condition of said identification means; and
beyond a specified duration, performing a monitoring of said pallet in order to verify its condition and carry out possible maintenance operations; then
attaching new identification means to said pallet.

2. Visual monitoring method according to claim 1, wherein the means for fastening said label are secured against tearing by means of areas of reduced resistance of said label.

3. Handling pallet insurance method, consisting, through contractual exchange between a pallet supplier and a customer, in monitoring the utilization time of each pallet in order to carry out, beyond a specified duration, the maintenance of said pallet and provide an insurance covering the risks in case of accidents and damages.

4. Insurance method according to claim 3, which consists in limiting the utilization time of a pallet to a given period through direct monitoring of said utilization time in order to ensure the maintenance of said pallet and to provide a guarantee against the risks in case of accidents and damages.
